(19) United States
(12) Patent Application Publication
(10) Pub. No.: US 2006/0293963 A1
(43) Pub. Date: Dec. 28, 2006

(54) Basket restaurant gift card

(76) Inventor: Robert S. Hoblit, Knightdale, NC (US)

Correspondence Address: MARCIA L. DOUBET LAW FIRM, P.O. BOX 422859, KISSIMMEE, FL, 34742-2589, US

(21) Appl. No.: 11/167,455

(22) Filed: Jun. 27, 2005

(51) Int. Cl. G06Q 50/00; G06Q 99/00; G06Q 30/00

(52) U.S. Cl. 705/15; 705/1

(57) ABSTRACT

Stored-value gift cards which gift-givers can purchase and give to recipients, where each card represents a set of items comprising a restaurant “meal profile”. The gift-giver can therefore provide a gift of an intended meal, rather than a gift of a fixed dollar value. Gift-givers may be required to prepay for such gift cards; alternatively, several deferred payment approaches may be supported. Techniques for resolving differences between the intended meal profile's value and the recipient's actual meal cost are addressed.

### BACKGROUND OF THE INVENTION

The present invention relates generally to “stored-value” cards, and more particularly, to stored-value cards for purchasers to buy as gifts, where each card represents a restaurant “meal profile” comprising a set of items (e.g., selected from categories or courses of the restaurant's menu).

Restaurant gift cards are a popular way to give a gift for any occasion. In some cases, the gift-giver selects a particular restaurant, and a monetary value for the gift card, because the restaurant is a place the recipient cannot afford or would not normally frequent (e.g., due to the lavishness of the restaurant). This can place the recipient in an awkward situation as he or she tries to balance taking advantage of the gift, yet not spending too much over the stored value of the card (since he or she will have to personally pay the difference). Even for patrons who can comfortably afford to pay the difference between a gift card and the meal, the gift card represents an “incomplete gift” when the recipient has to contribute personal funds.

On the other hand, if the recipient uses most of the gift card value, but less than the full value, he or she is left with the choice of forfeiting the remaining value on the card or returning to the restaurant a subsequent time to use the remaining value. With this latter choice, the recipient might have to spend a substantial amount of money for the difference between the subsequent meal cost and this remaining card value.

### BRIEF SUMMARY OF THE INVENTION

In one aspect, the present invention provides techniques for enabling use of restaurant basket gift cards, comprising: enabling a restaurant patron to redeem a restaurant basket gift card at a restaurant for which the gift card is gifted by a gift-giver, whereby the gift card represents a meal profile defined in view of the restaurant's menu and the patron exchanges the gift card for a meal consumed according to the gifted meal profile, the meal profile identifying a set of items comprising identified categories of food and beverages selectable from the menu, such that the gift-giver can gift the meal profile instead of a fixed dollar value

In another aspect, the present invention provides techniques for enabling restaurants to support use of restaurant gift cards, comprising: offering, by a restaurant, gift cards redeemable for meals consumed therein, wherein each of the gift cards represents a selectable one of a plurality of meal profiles consumable at the restaurant, each of the meal profiles specifying a particular quantity of meal items, each meal item corresponding to a category of consumable that is available from a menu of the restaurant, such that gift-givers can gift the offered cards to gift card recipients; and redeeming presented ones of the gift cards, by the restaurants, in exchange for a meal consumed therein.

In yet another aspect, the present invention provides: gift cards offered by a restaurant, the gift cards representing meal profiles for meals consumable at the restaurant, wherein each of the gift cards is redeemable for a meal consumed at the restaurant according to the represented meal profile, each meal profile identifying a plurality of courses of food and beverage available from a menu of the restaurant and a quantity for each of the identified courses; and techniques for supporting use of such cards, comprising: associating billing information of a purchaser with each purchased one of the offered gift cards, such that funds can be obtained from the purchaser to pay for the meal consumed according to the meal profile represented by the purchased gift card, upon redemption of the gift card by a gift recipient thereof; and using the associated billing information to obtain the funds from the purchaser upon the redemption.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIGS. 1A and 1B illustrate the front and back, respectively, of a sample basket gift card, according to one or more embodiments of the present invention;

FIG. 2 (comprising FIGS. 2A and 2B) provides a flowchart depicting logic that may be used when implementing one or more embodiments of the present invention;

FIG. 3 depicts a data processing system suitable for storing and/or executing program code; and

FIG. 4 depicts a sample communications network in which one or more embodiments of the present invention may be deployed.

### DETAILED DESCRIPTION OF THE INVENTION

Embodiments of the present invention are directed toward enabling givers of restaurant gift cards to provide a more pleasant experience for the gift card recipient, as contrasted to prior art techniques, such that the recipient's meal is more likely to be fully paid by the gift card, thereby providing the recipient with a more “complete” gift. A restaurant offers a gift card (referred to herein as a “gift card basket”, “basket gift card”, or equivalently, “gift card”) that covers some set of items in a “meal profile”, and the gift-giver can then offer the recipient a gift of a meal for some number of people (rather than the prior art approach of a gift that has a particular fixed dollar value). The “set of items”, as that term is used herein, refers to a general identification of categories (or courses) of food and/or beverages selectable from the restaurant's menu, rather than to particular pre-selected items. For example, a meal profile might specify that an entree course is included, rather than specifying a fixed choice of entree. (In some embodiments, the meal profile specifically identifies the number of people for which it is designed. In other embodiments, the meal profile may identify the set of items, where quantities of those items then vary depending on the number of people to which the meal profile is applied.)

According to preferred embodiments, basket gift cards are priced according to the particular restaurant in which they are redeemable, and the value of the card represents a typical meal for a selected number of people dining at that restaurant, according to a selected meal profile. A basket gift card can then be exchanged, by a gift recipient, for a meal that adheres to the gifted meal profile. For example, a gift card might be designed to cover the typical cost, at a particular restaurant, for a meal profile for 4 people where this meal profile includes 2 appetizers, 4 entrees, 1 round of non-alcoholic drinks, and 4 desserts.

Restaurants preferably offer gift cards for multiple party sizes, and may also offer a variety of meal profiles for the party sizes—such as one meal profile that includes alcoholic beverages and another that does not. Preferably, sales tax and a gratuity are included in the cost of each gift card (where these amounts may, for example, be computed as a percentage of the expected value of the meal profile). Using techniques disclosed herein, the gift-giver can then offer a gift card that represents a sentiment of (as an example), “I want to buy a nice dinner for you and your family.”.

A restaurant offering gift card baskets determines items comprising a particular meal profile (choosing, for example, whether or not the profile will include appetizers, and if so, how many), and then determines a typical cost for this meal profile in view of prices on the restaurant's menu. The advertised cost of the gift card for a selected meal profile is thus preferably set at a value that is likely to fully pay for the recipient's meal, according to that meal profile. (The recipient of the gift card may also be referred to herein as a restaurant patron; furthermore, a patron other than the recipient of the gift might redeem the gift card, in some situations, and thus the term “recipient” is used in a general sense.)

In one approach, the purchaser prepays for the gift card. In another approach, payment is deferred until the recipient uses the card. In yet another approach, a hold may be placed upon funds of the purchaser, but the finds are not actually obtained until the card is used. In still another approach, a partial prepayment is made, and the balance is then paid when the card is used.

Restaurants may offer gift card baskets wherein the recipient's usage of the card is to be fully paid by the gift-giver, such that the card is redeemed one-for-one for a meal with the number of people provided for in the selected meal profile. In addition or instead, restaurants may offer gift card baskets for which the gift-giver is responsible for paying an expected amount associated with the selected meal profile. Accordingly, the gift-giver may retain ongoing liability for deferred payment with regard to the actual cost of the recipient's meal, as will be discussed in more detail below.

When a restaurant allows payments for gift cards to be deferred, it may be desirable to (1) enforce a relatively short deadline for use of the gift card; (2) obtain additional information from the purchaser, such as a billing address for the purchaser's credit card; and/or (3) require a partial prepayment in an amount selected to limit potential liability (e.g., loss to the restaurant due to a purchaser closing the credit card account against which the remaining payment is to be charged, or perhaps increased cost of the gift due to the restaurant raising menu prices, and so forth). A credit card number (or other financial linkage information) of the purchaser may be associated with the gift card, as one approach to enabling deferred payment.

A restaurant may choose to support more than one of these strategies when allowing deferred payments, in addition to or instead of providing prepaid gift card baskets. Preferably, one or more embodiments of the present invention enable overcharges (which may be capped at a “not-to-exceed” value) to be charged to the purchaser and, in some embodiments, undercharges may be credited to the purchaser, as will be discussed in more detail below.

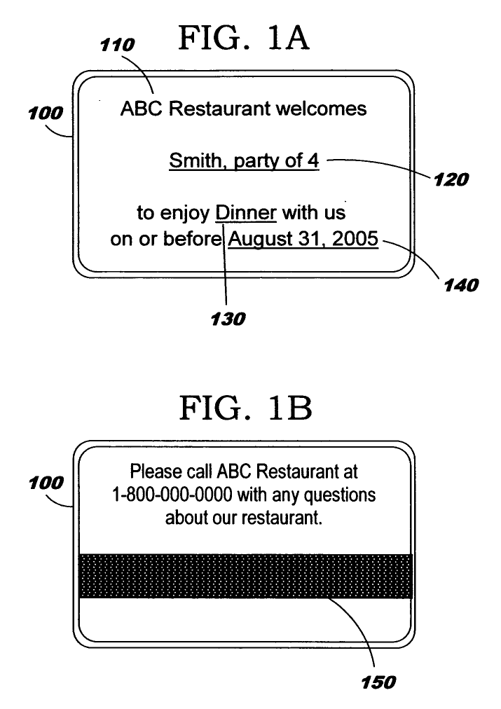

FIGS. 1A and 1B depict the front and back, respectively, of a sample restaurant gift card 100, representing a gift card basket as disclosed herein, that may be used with embodiments of the present invention. Preferably, the card resembles a credit or debit card. As shown in the example of FIG. 1A, the gift card is preferably designed with the name of the restaurant 110 on the front side. The example further shows that the card may show the gift recipient's name and the number of people covered by the gift-giver's selected meal profile (see 120) and perhaps identify which meal of the day is addressed by this profile (see 130). The example further illustrates that an expiration date for the gift card may be provided (see 140). When recipient-specific information of the type shown at 120-140 is provided on the gift card, the cards may be designed (for example) to include blank areas into which this information can be manually written upon purchase by the gift-giver.

FIG. 1B illustrates a magnetic stripe 150, which may be located on the back of the card. Preferably, this magnetic stripe is readable by magnetic stripe reader devices used to read credit and debit cards at a point-of-sale, and is encoded with information comprising one or more of: the selected meal profile, the value of that meal profile, the amount paid by the card purchaser, the not-to-exceed amount, the expiration date of the gift card, identifying information (such as a given name and surname) of the gift card recipient, identifying information of the gift card purchaser (which may include the purchaser's name, credit card number, billing address, etc.), or other pertinent information.

A basket gift card may be “loaded” with a monetary value corresponding to a particular meal profile using techniques known in the art for loading stored-value gift cards. For example, the magnetic stripe of the card may be passed through a card reader/write device which writes the monetary value into a predetermined area of the magnetic stripe. Other techniques may be used to establish the value associated with a particular card without deviating from the scope of the present invention.

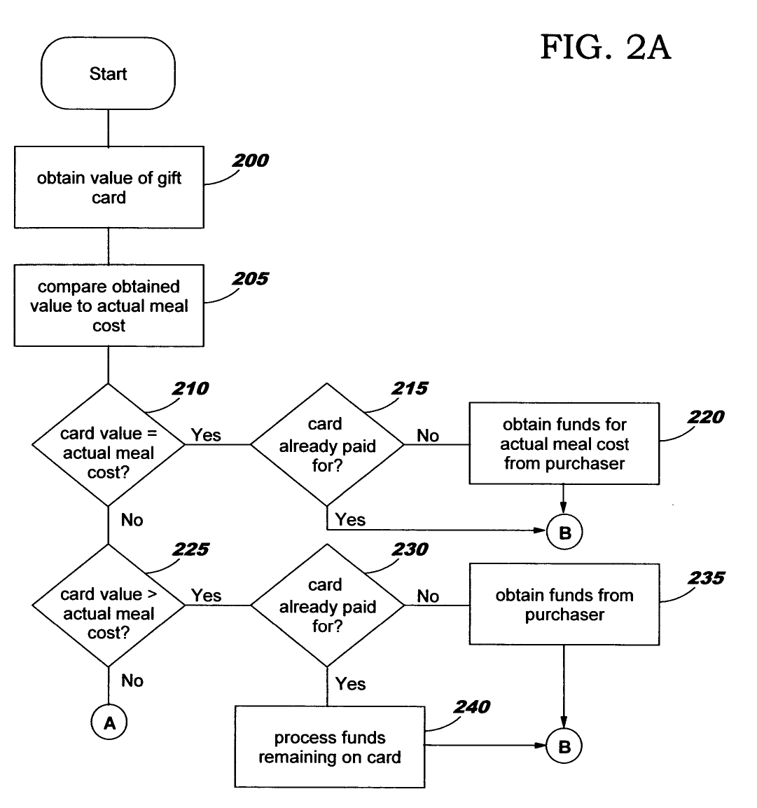

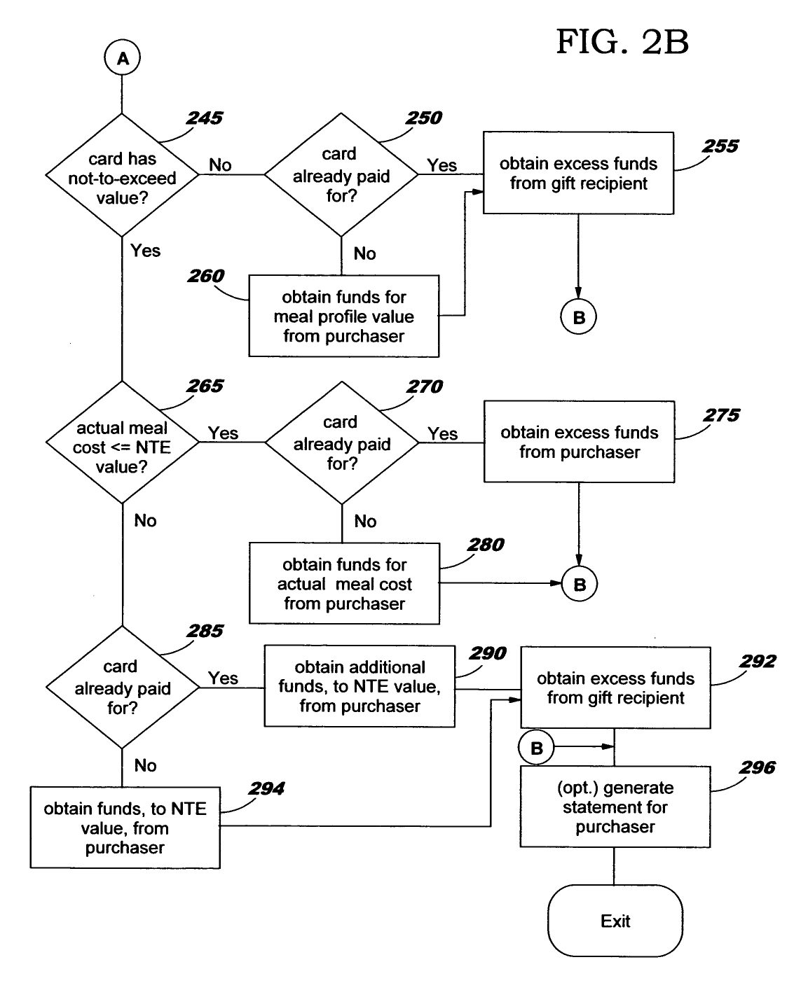

FIGS. 2A and 2B provide a flowchart that depicts logic which may be used when implementing one or more embodiments of the present invention. Referring first to FIG. 2A, the gift card recipient (or other person presenting the gift card for payment, referred to as the gift card recipient for ease of reference) presents the gift card upon completion of dining, for payment of the meal. The value of this particular card is then obtained (Block 200), preferably by reading the magnetic stripe on the card with a point-of-sale magnetic stripe reader device. The stored value of the gift basket card is compared to the recipient's actual meal cost (Block 205). Subsequent processing in FIG. 2 varies, depending on how these two values compare, as will now be discussed.

Blocks 210-220 address the case where the gift card value is identical to the recipient's actual meal cost. The test in Block 210 determines that the two values are equal, and processing therefore continues at Block 215 where a test is made to determine whether this gift card has already been paid for. If it has (i.e., Block 215 has a positive result), then control transfers to Block 296 of FIG. 2B. Otherwise (i.e., when the card has not been paid for), finds for the actual meal cost are obtained from the gift card purchaser (Block 220), and control also transfers to Block 296 of FIG. 2B from this processing path. As noted earlier, financial linkage information preferably associates the gift-giver with this particular gift card, thereby enabling the deferred payment represented by Block 220. (It should be noted that FIG. 2 and its corresponding description use the term “purchaser” when discussing gift cards, without regard to whether those cards have actually been paid for prior to their redemption. Furthermore, it may happen that an implementation of the present invention requires prepayment, or conversely does not, and in such cases, the results to the “card already paid for?” tests in FIG. 2 may be presumed as “yes” and “no”, respectively; such testing in the logic may then be omitted, if desired.)

Blocks 225-240 address the case where the gift card value is greater than the recipient's actual meal cost. When the test in Block 225 determines that the card value is greater than the meal cost, processing continues at Block 230 where a test is made to determine whether this gift card has already been paid for. Suppose, by way of example for this case, that the card purchaser intends to give a gift of a $50 meal profile, and that the recipient's actual meal cost is $43. The difference is therefore $7. Accordingly, when the test in Block 230 has a positive result (i.e., the gift card has already been paid for), then the purchaser has effectively overpaid for his or her intended gift. Several alternative approaches may be used to address this case, and the processing at Block 240 comprises an approach selected for a particular embodiment of the present invention.

As one approach, the amount paid by the purchaser is limited to the intended gift of a particular meal profile, such that the gift card is truly a one-time-use, complete gift. That is, the purchaser will pay for the recipient's actual meal cost, which for the example means that funds representing the actual meal cost will be obtained (Block 235) from the purchaser when the gift card has not been paid for; if the card has already been paid for (which, in the example, presumes that the purchaser already paid $50 for the card), then the excess payment (i.e., $7, in the example) will be returned to the purchaser (Block 240). In either case, control then transfers to Block 296 of FIG. 2B.

As an alternative approach for the case addressed by Blocks 225-240, the full cost of the intended meal profile may be obtained from the purchaser (Block 235), if the card has not been paid for. For the example, Block 235 therefore obtains $50 from the purchaser. The overpayment (of $7, for the example) may be left on the card at Block 240; or, the processing at Block 240 might, in some embodiments, comprise refunding the overpayment to the gift card recipient in cash. (As discussed earlier, a potential disadvantage of leaving the overpayment on the gift card is that the gift card recipient may have to spend considerable personal funds for a subsequent meal in order to use the card balance, or alternatively, may simply forfeit the remaining value of the card.)

Turning now to FIG. 2B, Blocks 245-294 address the case where the gift card value is less than the recipient's actual meal cost (and Block 296 depicts processing that may optionally be used with any or all of the cases). In this case, processing reaches Block 245, and a test is made to determine whether this gift card has a “not-to-exceed”, or “NTE”, value. This is an optional feature which may be used with one or more embodiments of the present invention. For example, the purchaser might intend to give a gift of a $50 meal profile, but recognizing the difficulty of spending exactly that amount, may further specify that up to $75 is authorized if the gift recipient's meal exceeds $50. In this example, the NTE value is therefore $75.

When the test in Block 245 has a negative result, indicating that the card does not include this NTE feature, processing continues at Block 250. Suppose, by way of example for this case, that the card purchaser intends to give a gift of a $50 meal profile, and that the recipient's actual meal cost is $60. The difference is therefore $10, and in the absence of an NTE feature, this excess $10 has to be paid by the gift card recipient. Thus, Block 250 tests to see if the purchaser has already paid for the gift card, and if not, then funds in the amount of the meal profile value ($50, for the example) are obtained from the purchaser at Block 260. Processing reaches Block 255 following execution of Block 260, and also when the test in Block 250 has a positive result. At Block 255, the excess funds ($10, in the example) are obtained from the gift card recipient. Control then transfers to Block 296.

When the gift card does include an NTE feature, processing reaches Block 265, which tests to see if the recipient's actual meal cost is less than or equal to the card's NTE value. Expanding on the example discussed with reference to Blocks 245-260, where the meal profile value is $50 and the recipient's actual meal cost is $60, further suppose that the card's NTE value is $75. In this example, the gift-giver has authorized full payment for the recipient's meal, even though the actual meal cost exceeded the intended gift value. The test in Block 265 has a positive result for this example, and control therefore reaches Block 270 which tests to see if the card has already been paid for. If so, then the purchaser owes excess funds beyond what he or she has already paid—namely, the difference between the actual meal cost and the amount paid for the intended meal profile. In the example, the excess funds amount is therefore $10. Block 275 therefore obtains the excess funds from the purchaser, after which control transfers to Block 296. If the card has not already been paid for (i.e., Block 270 has a negative result), then Block 280 obtains funds from the purchaser in the amount of the actual meal cost (which in the example is $60). Control also transfers to Block 296 from this processing path.

Control reaches Block 285 when the gift card includes an NTE feature, but the meal cost exceeds this particular NTE value. Suppose, by way of example for this case, that the card purchaser intends to give a gift of a $75 meal profile; that the card's NTE value is $100; and that the recipient's actual meal cost is $120. The excess over the NTE value is therefore $20, and this excess $20 has to be paid by the gift card recipient. Block 285 tests whether the gift card has already been paid for. If so, then additional funds, in an amount equal to the difference between NTE value and the amount already paid, are obtained from the purchaser (Block 290), and excess funds representing the difference between the recipient's actual meal cost and the NTE value are obtained from the gift recipient (Block 292). In the example, the additional funds obtained from the gift card purchaser are $25 and the excess funds obtained from the recipient are $20. Processing then continues at Block 296, discussed below.

When the test in Block 285 has a negative result (i.e., the card has not yet been paid for), then funds are obtained from the purchaser (Block 294) in the amount of the NTE value. In the example, Block 294 therefore obtains $100 from the purchaser. Control then transfers to Block 292 where, as discussed above, the excess funds ($20, in the example) are obtained from the gift recipient. Processing then continues at Block 296.

Block 296 represents optional processing, whereby a statement (or other accounting) may be generated for the purchaser. Use of this option may be limited, in some embodiments, to particular scenarios. For example, statements might be generated where the purchaser has not prepaid for the card (e.g., following processing at Block 220) and/or where the purchaser has made a prepayment but excess/additional funds are obtained from the purchaser when the card is presented for payment (e.g., following processing at Block 275 or Block 290). In addition or instead, statements might be generated when the purchaser has overpaid for the gift card (e.g., following processing at Block 240). Upon completion of the processing of Block 296, FIG. 2 then exits.

Note that cards with an NTE feature may be used for meal payment in cases where the recipient's actual meal cost is less than an amount the gift-giver has already paid for the card. In this case, Block 240 preferably comprises additional processing that effectively cancels the NTE feature. Suppose, as an extension to the example discussed with reference to Blocks 225-240, that the gift card has an NTE value of $55. Cancelling the NTE feature means that, in the approach where the remaining funds are left on the card for subsequent use, the gift recipient can use the remaining $7 (i.e., the difference between the $50 already paid for the card and the $43 cost of the recipient's meal) for a subsequent meal but cannot take advantage of the additional $5 by which the NTE value exceeds the intended meal profile value.

The intended meal profile value for a particular gift card may be known to the gift card recipient. For example, the recipient may be told that the meal profile is valued at $50, such that the recipient (and guests, when applicable) can attempt to reach that amount. As an alternative, the card value might be advertised to the recipient only in terms of the meal profile. For example, the recipient might be told that the gift card represents a meal profile for 4 people, where that meal profile includes 4 choices of salad or soup, 4 entrees, 4 desserts, and so forth.

As will be appreciated by one of skill in the art, selected components of the present invention may be provided as methods, systems, and/or computer program products comprising computer-readable program code. Accordingly, components of the present invention may be embodied in hardware/firmware. An embodiment combining software and hardware aspects, or an embodiment in software only, might be used alternatively.

Furthermore, components of the invention may take the form of a computer program product accessible from computer-usable or computer-readable media providing program code for use by, or in connection with, a computer or any instruction execution system. For purposes of this description, a computer-usable or computer-readable medium can be any apparatus that can contain, store, communicate, propagate, or transport a program for use by, or in connection with, the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, removable computer diskette, random access memory (“RAM”), read-only memory (“ROM”), rigid magnetic disk, and optical disk. Current example of optical disks include compact disk with read-only memory (“CD-ROM”), compact disk with read/write (“CD-R/W”), and DVD.

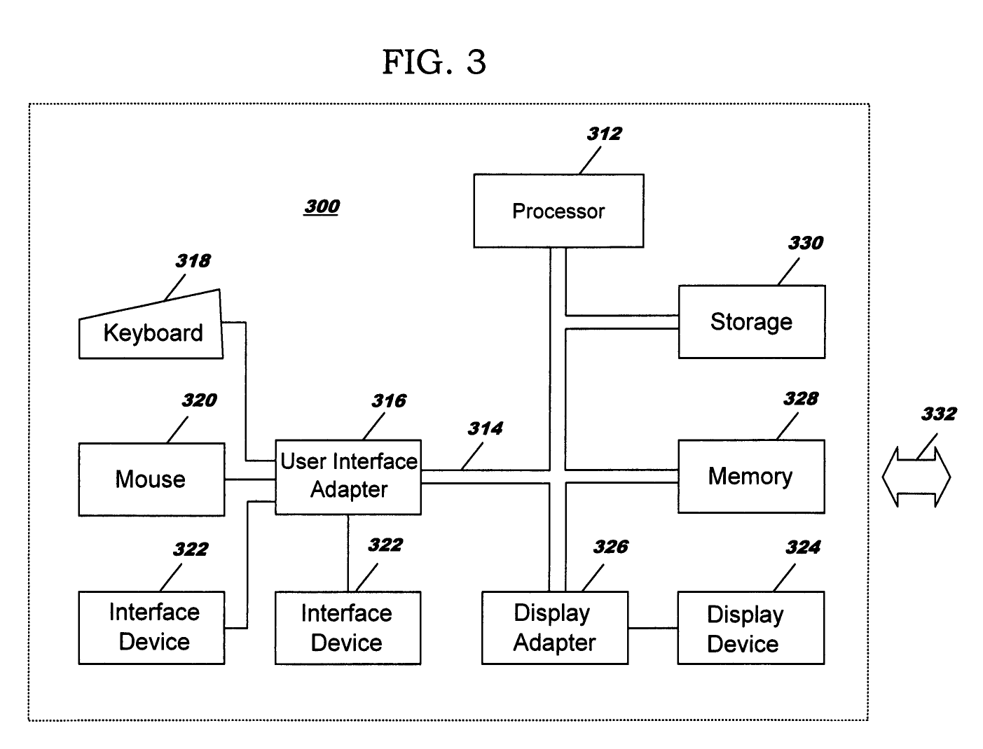

Referring now to FIG. 3, a data processing system 300 suitable for storing and/or executing program code includes at least one processor 312 coupled directly or indirectly to memory elements through a system bus 314. The memory elements can include local memory 328 employed during actual execution of the program code, bulk storage 330, and cache memories (not shown) which provide temporary storage of at least some program code in order to reduce the number of times code must be retrieved from bulk storage during execution.

Input/output (I/O″) devices (including but not limited to keyboards 318, displays 324, pointing devices 320, other interface devices 322, etc.) can be coupled to the system either directly or through intervening I/O controllers or adapters (316, 326).

Network adapters may also be coupled to the system to enable the data processing system to become coupled to other data processing systems or remote printers or storage devices through intervening private or public networks (as shown generally at 332). Modems, cable modem attachments, wireless adapters, and Ethernet cards are just a few of the currently-available types of network adapters.

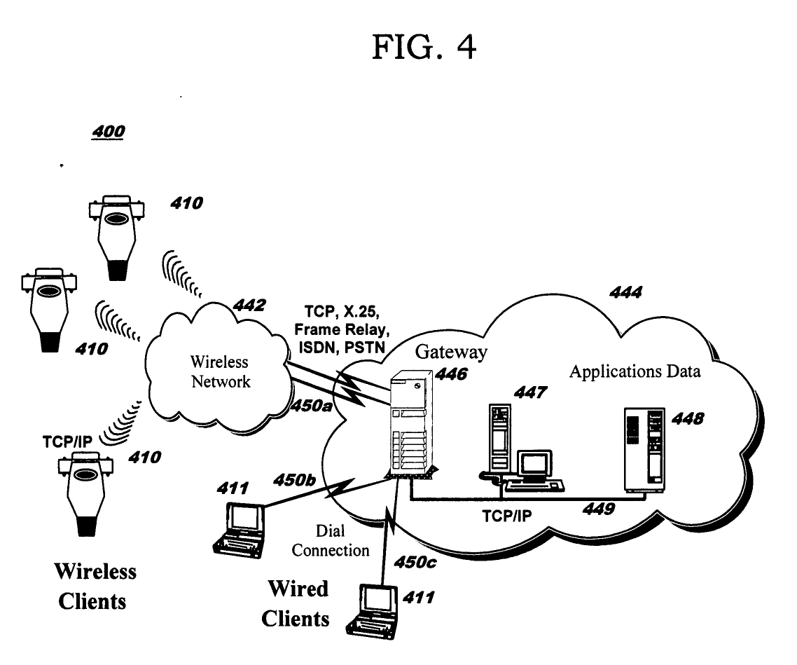

FIG. 4 illustrates a sample communications network in which one or more embodiments of the present invention may be deployed. The data processing network 400 may include a plurality of individual networks, such as wireless network 442 and network 444. A plurality of magnetic stripe reader devices 410 (as well as other devices, not shown) may communicate over wireless network 442, and a plurality of devices, shown in the figure (by way of illustration) as workstations 411, may communicate over network 444. Additionally, as those skilled in the art will appreciate, one or more local area networks (“LANs”) may be included (not shown), where a LAN may comprise a plurality of devices coupled to a host processor.

Still referring to FIG. 4, the networks 442 and 444 may also include mainframe computers or servers, such as a gateway computer 446 or application server 447 (which may access a data repository 448). A gateway computer 446 serves as a point of entry into each network 444. The gateway 446 may be preferably coupled to another network 442 by means of a communications link 450a. The gateway 446 may also be directly coupled to one or more workstations 411 using a communications link 450b, 450c, and/or may be indirectly coupled to such devices. The gateway computer 446 may be implemented utilizing an Enterprise Systems Architecture/370™ available from the International Business Machines Corporation (“IBM®”), an Enterprise Systems Architecture/390® computer, etc. Depending on the application, a midrange computer, such as an Application System/400® (also known as an AS/400®) may be employed. (“Enterprise Systems Architecture/370” is a trademark of IBM; “IBM”, “Enterprise Systems Architecture/390”, “Application System/400”, and “AS/400” are registered trademarks of IBM.)

The gateway computer 446 may also be coupled 449 to a storage device (such as data repository 448).

Those skilled in the art will appreciate that the gateway computer 446 may be located a great geographic distance from the network 442, and similarly, the magnetic stripe reader devices 410 and/or workstations 411 may be located some distance from the networks 442 and 444, respectively. For example, the network 442 may be located in California, while the gateway 446 may be located in Texas, and one or more of the workstations 411 may be located in Florida. The magnetic stripe reader devices 410 may connect to the wireless network 442 using a networking protocol such as the Transmission Control Protocol/Internet Protocol (“TCP/IP”) over a number of alternative connection media, such as cellular phone, radio frequency networks, satellite networks, etc. The wireless network 442 preferably connects to the gateway 446 using a network connection 450a such as TCP or User Datagram Protocol (“UDP”) over IP, X.25, Frame Relay, Integrated Services Digital Network (“ISDN”), Public Switched Telephone Network (“PSTN”), etc. The workstations 410 may connect directly to the gateway 446 using dial connections 450b or 450c. Further, the wireless network 442 and network 444 may connect to one or more other networks (not shown), in an analogous manner to that depicted in FIG. 4.

While preferred embodiments of the present invention have been described, additional variations and modifications in those embodiments may occur to those skilled in the art once they learn of the basic inventive concepts. Therefore, it is intended that the appended claims shall be construed to include preferred embodiments and all such variations and modifications as fall within the spirit and scope of the invention. Furthermore, it should be understood that use of “a” or “an” in the claims is not intended to limit embodiments of the present invention to a singular one of any element thus introduced.

1. A method of enabling use of restaurant basket gift cards, comprising a step of:
enabling a restaurant patron to redeem a restaurant basket gift card at a restaurant for which the gift card is gifted by a gift-giver, whereby the gift card represents a meal profile defined in view of the restaurant's menu and the patron exchanges the gift card for a meal consumed according to the gifted meal profile, the meal profile identifying a set of items comprising identified categories of food and beverages selectable from the menu, such that the gift-giver can gift the meal profile instead of a fixed dollar value.

2. The method according to claim 1, wherein the categories are courses of food and beverages selectable from the menu.

3. The method according to claim 1, wherein the meal profile further identifies a quantity of each of the items for which the gift card can be redeemed.

4. The method according to claim 1, wherein the gift-giver prepays, for the gift card, an amount comprising an expected value of the gifted meal profile.

5. The method according to claim 4, wherein the gift-giver subsequently pays an additional amount upon the redemption of the gift card, the additional amount comprising a difference by which a cost of the consumed meal exceeds the amount of the prepayment.

6. The method according to claim 4, wherein the gift card includes a not-to-exceed value specified by the gift-giver, and wherein the gift-giver subsequently pays an additional amount upon the redemption of the gift card, the additional amount comprising a lesser one of (1) a difference by which a cost of the consumed meal exceeds the amount of the prepayment and (2) an excess by which the not-to-exceed value exceeds the amount of the prepayment.

7. The method according to claim 4, wherein financial linkage information of the gift-giver is associated with the gift card to enable the gift-giver to make a subsequent payment or to enable returning a portion of the prepaid amount to the gift-giver, upon the redemption of the gift card, depending on whether the consumed meal is more or less expensive, respectively, than the expected value.

8. The method according to claim 1, wherein:
the gift-giver prepays, for the gift card, an amount comprising a portion of an expected value of the gifted meal profile; and
billing information of the gift-giver is associated with the gift card, such that a subsequent payment can be made by the gift-giver, upon the redemption of the gift card, in view of a cost of the consumed meal.

9. A method of enabling restaurants to support use of restaurant gift cards, comprising steps of:
offering, by a restaurant, gift cards redeemable for meals consumed therein, wherein each of the gift cards represents a selectable one of a plurality of meal profiles consumable at the restaurant, each of the meal profiles specifying a particular quantity of meal items, each meal item corresponding to a category of consumable that is available from a menu of the restaurant, such that gift-givers can gift the offered cards to gift card recipients; and
redeeming presented ones of the gift cards, by the offering restaurant, in exchange for a meal consumed therein.

10. A system for supporting use of restaurant gift cards, comprising:
gift cards offered by a restaurant, the gift cards representing meal profiles for meals consumable at the restaurant, wherein each of the gift cards is redeemable for a meal consumed at the restaurant according to the represented meal profile, each meal profile identifying a plurality of courses of food and beverage available from a menu of the restaurant and a quantity for each of the identified courses;
means for associating billing information of a purchaser with each purchased one of the offered gift cards, such that funds can be obtained from the purchaser to pay for the meal consumed according to the meal profile represented by the purchased gift card, upon redemption of the gift card by a gift recipient thereof; and
means for using the associated billing information to obtain the funds from the purchaser upon the redemption.

11. The system according to claim 10, wherein the gift cards comprise a magnetic stripe readable by a magnetic stripe reader, the magnetic stripe encoded with information usable by the means for associating, such that the funds can be obtained using the encoded information.

12. The system according to claim 10, further comprising means for enabling the purchaser to prepay an amount comprising an expected value of the meal profile represented by the purchased gift card, and wherein the means for using the associated billing information further comprises means for using the associated billing information to obtain additional funds from the purchaser, the additional funds comprising a difference by which a cost of the meal consumed according to the meal profile exceeds the prepaid amount.

13. The system according to claim 10, wherein the purchased gift card includes a not-to-exceed value specified by the purchaser, and further comprising means for enabling the purchaser to prepay an amount comprising a portion of an expected value of the meal profile represented by the purchased gift card, and wherein the means for using the associated billing information further comprises means for using the associated billing information to obtain additional funds from the purchaser, the additional funds comprising a lesser one of (1) a difference by which a cost of the meal consumed according to the meal profile exceeds the prepaid amount and (2) an excess by which the not-to-exceed value exceeds the prepaid amount.

14. The system according to claim 10, wherein the meal profile further identifies a quantity of each of the items for which the purchased gift card can be redeemed.

15. A computer program product for supporting use of restaurant gift cards, the computer program product comprising computer-readable code embodied on one or more computer-usable media, the computer-readable code comprising instructions that when executed on a computer cause the computer:
obtain information read, from a magnetic stripe of a gift card presented for redemption at a restaurant by a restaurant patron, by a magnetic stripe reader, the information comprising financial linkage information of a purchaser of the presented gift card and a meal profile represented by the presented gift card, wherein the meal profile indicates identified categories of food and beverages selectable by the restaurant patron from a menu of the restaurant; and
use the financial linkage information to obtain funds from the purchaser for payment of a meal consumed by the restaurant patron according to the meal profile.

16. The computer program product according to claim 15, wherein the meal profile further indicates a quantity of each of the identified categories for which the purchased gift card can be redeemed by the restaurant patron.

17. The computer program product according to claim 15, wherein the computer-readable code further comprising instructions that when executed on the computer cause the computer to:
obtain, from the purchaser when the gift card is purchased, a prepayment amount comprising an expected value of the meal profile represented by the purchased gift card; and
use the financial linkage information to obtain additional funds from the purchaser, the additional funds comprising a difference by which a cost of the meal consumed according to the meal profile exceeds the prepayment amount

18. The computer program product according to claim 15, wherein the obtained information further comprises a not-to-exceed value specified by the purchaser, and wherein the computer-readable code further comprising instructions that when executed on the computer cause the computer to:
obtain, from the purchaser when the gift card is purchased, a prepayment amount comprising an expected value of the meal profile represented by the purchased gift card; and
use the financial linkage information to obtain additional funds from the purchaser, the additional finds comprising a lesser one of (1) a difference by which a cost of the meal consumed according to the meal profile exceeds the prepaid amount and (2) an excess by which the not-to-exceed value exceeds the prepayment amount.
